(19) United States
(12) Patent Application Publication
(10) Pub. No.: US 2022/0106999 A1
(43) Pub. Date: Apr. 7, 2022

(54) CYLINDER DEVICE

(71) Applicant: HITACHI ASTEMO, LTD., Ibaraki (JP)

(72) Inventors: Satoshi ISHII, Tokyo (JP); Motohiro HIRAO, Hitachinaka-shi, Ibaraki (JP)

(73) Assignee: HITACHI ASTEMO, LTD., Ibaraki (JP)

(21) Appl. No.: 17/423,212

(22) PCT Filed: Aug. 15, 2019
(86) PCT No.: PCT/JP2019/032021

§ 371 Date: Jul. 15, 2021

(30) Foreign Application Priority Data
Jan. 28, 2019 (JP) 2019-012061

(51) Int. Cl. F16F 9/53; F16F 9/18

(52) U.S. Cl. CPC F16F 9/532; F16F 9/185

(57) ABSTRACT

A cylinder device including: a piston rod having a piston; a first electrode that constitutes an inner cylinder and into which the piston rod is inserted; a second electrode that constitutes an outer cylinder and is provided so as to face an outer peripheral surface of the first electrode; a base shell that houses the first electrode and the second electrode; an electroviscous fluid sealed inside the base shell; and a voltage application unit that applies a voltage between the first electrode and the second electrode, and an outer surface insulation layer is provided on an outer peripheral surface of the second electrode. Thus, it is possible to prevent deposition of particles in a region where the electroviscous fluid sealed in the cylinder device is low in speed, and to suppress deterioration of the damping characteristics of the cylinder device.

### TECHNICAL FIELD

The present invention relates to a cylinder device.

### BACKGROUND ART

Normally, a vehicle includes a cylinder device for damping vibration during traveling in a short time to improve ride comfort and traveling stability.

A cylinder device using an electroviscous fluid (electrorheological fluid composition: ERF) for controlling a damping force according to a road surface condition or the like is known.

PTL 1 discloses a device that controls transmission of a force formed by interposing, between electrodes, an electrorheological fluid composition containing particles having an electrorheological effect in an electrically insulating medium, in which the electrically insulating medium includes two or more types of media phase-separated from each other and having different specific gravity, and at least one type of the electrically insulating media has a specific gravity larger than that of the particles. PTL 1 describes that with this configuration, the above-described particles are easily re-dispersed by slight agitation without precipitating to the bottom of the vessel in the medium.

PTL 2 discloses a cylinder device for buffering vibrations of an automobile, a railway vehicle, and the like, the cylinder device being capable of tuning damping force characteristics by the configuration having an inner cylinder, an outer cylinder, and an electrode cylinder, in which a functional fluid having the fluid property changing due to an electric field or a magnetic field is sealed, and in which an adjustment valve is provided on the downstream side of the electrode passage.

PTL 3 discloses an electrode for applying voltage to an electroviscous fluid used in a mechanical device such as a clutch, a valve, and a shock absorber, where durability of the electrode is improved by laminating an insulation layer on a contact surface with the electroviscous fluid. This literature discloses materials such as fluorine resin (polytetrafluoroethylene) and polyethylene terephthalate as organic insulation layer formation materials.

### CITATION LIST

### Patent Literature

PTL 1: JP H8-127790 A

PTL 2: JP 2017-15244 A

PTL 3: JP H3-113129 A

### SUMMARY OF INVENTION

### Technical Problem

The device described in PTL 1 provides a solution to the problem of precipitation of particles contained in an electrorheological fluid composition, but does not solve the problem of adhesion of particles to an electrode.

The cylinder device described in PTL 2 is provided with an adjustment valve for adjusting damping force characteristics, but does not solve the problem of adhesion of particles to an electrode.

By providing an insulation layer on a contact surface with an electroviscous fluid, the electrode for applying voltage described in PTL 3 solves problems such as electrochemical consumption of water, polyhydric alcohol, and the like used as a polarization accelerator and elution of a metal electrode due to an electrochemical reaction or the like.

In a cylinder device using an electroviscous fluid, a large potential difference is generated between an electrode and a base shell or between electrodes, and hence durability of the electrode is required, and there is a concern that particles contained in the electroviscous fluid adhere to the electrode in a low-speed region due to force from the electrode. The adhesion of particles to the electrode results in deterioration of the damping characteristics of the cylinder device.

An object of the present invention is to prevent deposition of particles in a region where the electroviscous fluid sealed in the cylinder device is low in speed, and to suppress deterioration of the damping characteristics of the cylinder device.

### Solution to Problem

The cylinder device of the present invention includes: a piston rod having a piston; a first electrode that constitutes an inner cylinder and into which the piston rod is inserted; a second electrode that constitutes an outer cylinder and is provided so as to face an outer peripheral surface of the first electrode; a base shell that houses the first electrode and the second electrode; an electroviscous fluid sealed inside the base shell; and a voltage application unit that applies a voltage between the first electrode and the second electrode, and an outer surface insulation layer is provided on an outer peripheral surface of the second electrode.

### Advantageous Effects of Invention

According to the present invention, it is possible to prevent deposition of particles in a region where the electroviscous fluid sealed in the cylinder device is low in speed, and to suppress deterioration of the damping characteristics of the cylinder device.

### BRIEF DESCRIPTION OF DRAWINGS

FIG. 1 is a schematic longitudinal sectional view illustrating a basic structure of a conventional cylinder device.

FIG. 2 is a schematic longitudinal sectional view illustrating a cylinder device according to a first embodiment of the present invention.

FIG. 3 is a schematic longitudinal sectional view illustrating a cylinder device according to a second embodiment of the present invention.

### DESCRIPTION OF EMBODIMENTS

First, the basic structure of the cylinder device will be described.

The cylinder device is a device provided one by one corresponding to each wheel of the vehicle, and mitigates impact and vibration generated between the body and the axle of the vehicle.

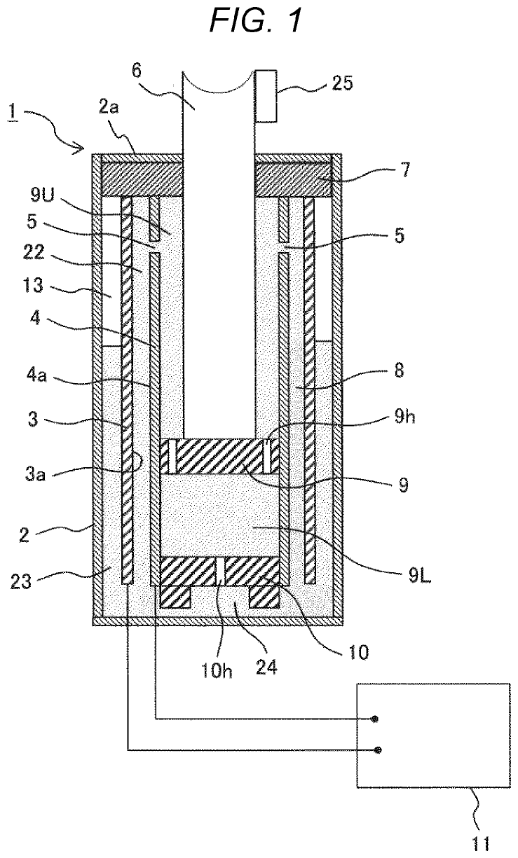

FIG. 1 is a schematic longitudinal sectional view illustrating the basic structure of a conventional cylinder device. This figure is an example in which an electrode is not provided with an insulation layer.

As shown in the figure, a cylinder device 1 includes a rod 6 (piston rod) provided with a piston 9 at one end (lower end in the figure) and a head at the other end (not illustrated), a cylindrical base shell 2 (container) constituting an outer shell of the cylinder device 1, an inner cylinder 4 (cylinder), and an outer cylinder 3. The outer cylinder 3 is a cylindrical member provided between the base shell 2 and the inner cylinder 4. The rod 6, the inner cylinder 4, the outer cylinder 3, and the base shell 2 are concentrically arranged. An electroviscous fluid 8 is sealed in the base shell 2.

A flow path 22 for the electroviscous fluid 8 is formed between the inner cylinder 4 and the outer cylinder 3. A flow path 23 for the electroviscous fluid 8 is formed between the outer cylinder 3 and the base shell 2.

The piston 9 is inserted into the inner cylinder 4 in a vertically slidable manner. The inside of the inner cylinder 4 is partitioned into a piston lower chamber 9L and a piston upper chamber 9U by the piston 9. A plurality of vertically penetrating through holes 9h are arranged circumferentially in the piston 9 at equal intervals. The piston lower chamber 9L and the piston upper chamber 9U are communicated with each other via the through hole 9h. The through hole 9h is provided with a check valve, and the electroviscous fluid 8 flows in one direction through the through hole 9h.

A body 10 is provided at the lower end of the inner cylinder 4. The body 10 is provided with a through hole 10h. A flow path 24 is formed below the body 10, i.e., between the body 10 and the bottom plate of the base shell 2. The piston lower chamber 9L is communicated with the flow path 24 via the through hole 10h. The flow path 22 and the flow path 23 are communicated with each other via the flow path 24.

The base shell 2 is provided with an upper end plate 2a. The upper end plate 2a is provided with an oil seal 7. The rod 6 is installed so as to penetrate the upper end plate 2a and the oil seal 7. The piston 9 provided at the lower end of the rod 6 is arranged in the inner cylinder 4. The upper ends of the outer cylinder 3 and the inner cylinder 4 are in contact with the oil seal 7. This can prevent the electroviscous fluid 8 sealed in the base shell 2 from leaking.

The space above the flow path 23 is filled with an inert gas 13. The inert gas 13 may be nitrogen or the like.

An inner peripheral surface of the outer cylinder 3 is provided with an outer electrode 3a. The inner cylinder 4 functions as an electrode. Hereinafter, the inner cylinder 4 is also referred to as an inner electrode 4a.

A voltage application unit 11 is connected to the outer electrode 3a and the inner electrode 4a. Thus, a voltage is applied between the outer electrode 3a and the inner electrode 4a. In the present description, the inner electrode 4a is also referred to as a “first electrode” and the outer electrode 3a is also referred to as a “second electrode”.

The outer electrode 3a and the inner electrode 4a are in direct contact with the electroviscous fluid 8. For this reason, it is desirable that a material that is less likely to cause electrolytic corrosion or corrosion that are caused by the component contained in the electroviscous fluid 8 be employed as the material of the outer electrode 3a and the inner electrode 4a. In addition, as the material of the outer electrode 3a and the inner electrode 4a, an electrode material in which corrosion resistance has been improved by using a corrosion-prone metal as a base material and coating the surface of the base material with a corrosion-resistant metal by plating treatment or the like may be employed.

As the material of the oil seal 7, for example, a rubber material such as nitrile rubber or fluorine rubber can be employed. The oil seal 7 is in direct contact with the electroviscous fluid 8. Therefore, in order to make the oil seal 7 less likely to be damaged by particles contained in the electroviscous fluid 8, the oil seal 7 is desirably made of a material having a hardness equal to or greater than the hardness of the particles. In other words, the particles used as the components of the electroviscous fluid 8 are desirably made of a material having a hardness equal to or less than the hardness of the oil seal 7.

Details of the particles contained in the electroviscous fluid 8 will be described later.

The vicinity of the upper end of the inner cylinder 4 is provided with a plurality of radially penetrating lateral holes 5 at equal intervals circumferentially. The lateral hole 5 communicates the piston upper chamber 9U with the flow path 22.

When the vehicle is traveling on an uneven road, the vehicle body vibrates. Upon receiving this vibration, the rod 6 vibrates inside the inner cylinder 4. Thus, the volumes of the piston lower chamber 9L and the piston upper chamber 9U each changes.

The vehicle body (not illustrated) is provided with an acceleration sensor 25. This figure illustrates the acceleration sensor 25 as being attached to the upper part of the rod 6. The actual installation position of the acceleration sensor 25 is not limited to this.

The acceleration sensor 25 detects acceleration of the vehicle body and outputs the detected signal to the voltage application unit 11. The voltage application unit 11 determines a voltage to be applied to the electroviscous fluid 8 based on a signal from the acceleration sensor 25 or the like.

The voltage application unit 11 calculates a voltage for generating a necessary damping force based on the detected acceleration, and applies a voltage between the outer electrode 3a and the inner electrode 4a based on the result, thereby exerting an electroviscous effect. When a voltage is applied by the voltage application unit 11, the viscosity of the electroviscous fluid 8 changes according to the voltage. By adjusting the applied voltage based on the acceleration, the voltage application unit 11 controls the damping force of the cylinder device 1 and improves the ride comfort of the vehicle.

Since the base shell 2 is grounded, a potential difference is generated between the outer electrode 3a (outer cylinder 3) and the base shell 2 by applying a voltage to the outer electrode 3a (outer cylinder 3).

Embodiments of the present invention will be described below with reference to the drawings. In the following description, only matters different from those in FIG. 1 will be described.

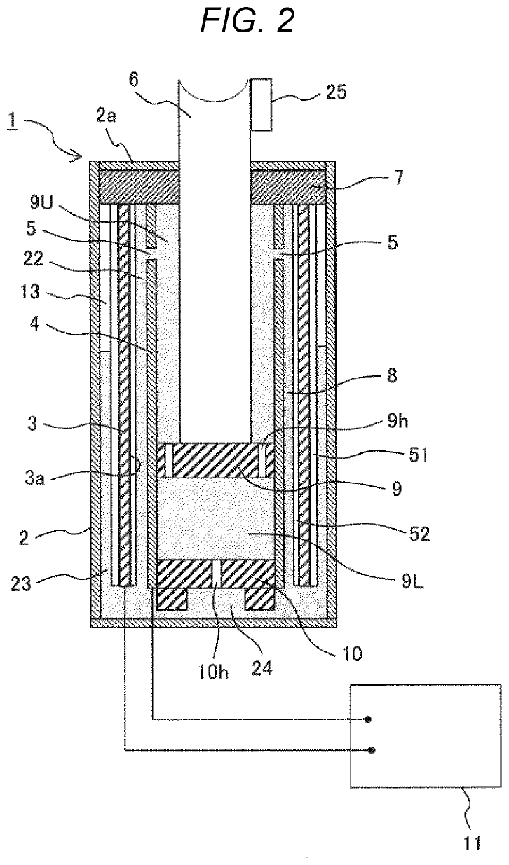

FIG. 2 is a schematic longitudinal sectional view illustrating the cylinder device according to the first embodiment of the present invention.

In this figure, an insulation layer 51 is provided on the outer surface of the outer cylinder 3, and an insulation layer 52 is provided on the inner surface of the outer cylinder 3. The insulation layers 51 and 52 are formed of resin.

The insulation layer 51 suppresses an electric field generated between the outer cylinder 3 and the base shell 2.

The insulation layer 52 suppresses deterioration due to electrode reaction.

By providing the insulation layers 51 and 52, it is possible to achieve both durability of the electrode and suppression of deterioration in damping characteristics.

In the insulation layers 51 and 52, appropriate film thicknesses are different from each other. In order to ensure high damping force, high safety, and high durability as the cylinder device 1, it is desirable that the insulation layer 52 be thinner than the insulation layer 51.

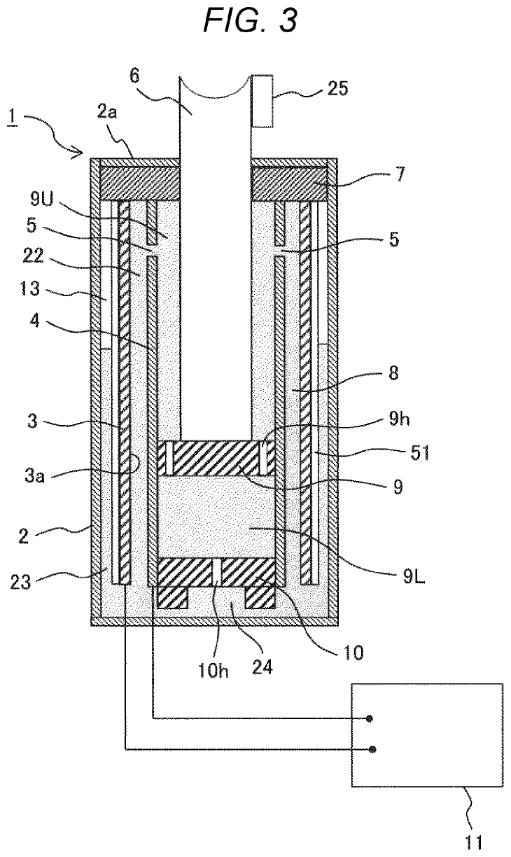

FIG. 3 is a schematic longitudinal sectional view illustrating the cylinder device according to the second embodiment of the present invention.

In this figure, the insulation layer 51 is provided on the outer surface of the outer cylinder 3. No insulation layer is provided on the inner surface of the outer cylinder 3.

Therefore, the present embodiment can be applied as long as the electrode reaction does not become a problem in a state where there is no insulation layer on the inner surface of the outer cylinder 3. In other words, if the outer electrode 3a is formed of a material having excellent corrosion resistance, such as stainless steel or titanium, and the deterioration can be sufficiently suppressed, the insulation layer 52 shown in FIG. 2 may not necessarily be provided. That is, the effect of the present invention can be achieved by providing only the insulation layer 51 as shown in FIG. 3. That is, by providing the insulation layer 51, it is possible to suppress the electric field and prevent the deposition of particles in the region where the electroviscous fluid becomes slow.

The electroviscous fluid 8 is a suspension in which particles having insulating properties are dispersed in a dispersion medium including a liquid (hereinafter referred to as “base oil”) having insulating properties. The particles having insulating properties are also referred to as a “dispersed phase”.

The type of the base oil is not particularly limited as long as it can disperse particles having insulating properties. Specifically, silicone oil or mineral oil such as paraffin oil and naphthene oil can be employed as the base oil. Since the viscosity of the base oil contributes to the viscosity of the electroviscous fluid 8 and the temperature dependence of the viscosity, the viscosity is preferably 50 mm²/s or less, more preferably 10 mm²/s or less.

[Particles Constituting Dispersed Phase]

As described above, the particles constituting the dispersed phase are particles having insulating properties.

Specific examples of particle materials include organic matters such as methacrylic resins, polyurethane resins, acrylic resins, ion exchange resins, phenolic resins, high-density polyethylene, high-density polypropylene, polyimide, polyamide, and polyaniline (organic semiconductors), and non-conductive metal oxides such as silica, alumina, and thiania, and ceramics. Furthermore, examples of the particles include composite particles in which organic particles are coated with a metal oxide, and composite particles in which metal particles or organic particles are coated with an organic semiconductor. Hollow organic particles can also be employed.

The average particle size (diameter) of the particles constituting the dispersed phase is not particularly limited. In consideration of the responsiveness of the electroviscous effect and the magnitude of the effect, the preferred average particle size is 1 μm to 10 μm, more preferably 3 μm to 7 μm, from the point of view of the mobility of the particles and the viscosity increase width. [Insulation layer]

The material of the insulation layers 51 and 52 illustrated in FIGS. 2 and 3 is not particularly limited as long as it can form a layer having insulating properties.

Specific example include polyamide, polyamideimide, polyimide, an epoxy resin, polyethylene terephthalate, polyethylene, a phenol resin, fluorine resins having a perfluoro skeleton such as polytetrafluoroethylene (PTFE), and silicone resins having a silicone skeleton. In particular, since the fluorine resins have a large contact angle due to water, exhibit water repellency, and have a low surface energy, the effect of weakening the electric field and the effect of suppressing adhesion of particles can be simultaneously enhanced by forming the insulation layer. Therefore, it is desirable for formation of an insulation layer on the base shell side of the outer electrode 3a.

Note that the contact angle due to water is generally water repellent at 90° or more and super water repellent at 150° or more, and the larger the angle is, the higher the water repellency is. There is a critical surface tension (surface tension of the liquid such that the contact angle becomes 0° with respect to the solid surface: the smaller the surface tension is, the smaller the surface energy is and the higher the water repellency is), which is an index of surface energy.

For example, regarding the contact angle and critical surface tension of water, in the above-described insulation layer material, nylon that is polyamide has a contact angle of 77° and a critical surface tension of 46 dyne/cm. Polyethylene terephthalate has a contact angle of 79° and a critical surface tension of 43 dyne/cm. Polyethylene has a contact angle of 88° and a critical surface tension of 31 dyne/cm. Phenol resin has a contact angle of 80°, and the critical surface tension is too large to calculate theoretically. In contrast, PTFE has a contact angle of 114° and a critical surface tension of 18 dyne/cm. PTFE has a larger contact angle due to water and a smaller critical surface tension (surface energy) than general resin materials have.

Thus, the contact angle due to water is preferably 90° or more, which shows water repellency, and more practically preferably 110° or more, which can be achieved without special treatment such as fine processing on the solid surface. However, realization of a higher contact angle by applying special processing to the surface of the insulation layer may be applied because it is considered that the effect of the present invention appears remarkably. For the same reason, the critical surface tension is preferably 20 dyne/cm or less for the surface energy.

The material may be a single material or a composite material in which a plurality of materials are mixed. Furthermore, the surface may be modified by applying surface treatment to the resin layer formed of an easily molded material. For example, the surface of the resin layer formed of polyamide may be modified with a fluorine surface treatment agent having a perfluoro skeleton.

In this description, a fluorine resin, a fluorine surface treatment agent, and the like are collectively referred to as a “fluorine material”. The insulation layers 51 and 52 are desirably configured to contain a fluorine material.

As for the thickness of the insulation layer, as described above, the insulation layer 52 is thinner than the insulation layer 51 (FIG. 2). When the electrode material has high corrosion resistance, it is not necessarily to provide the insulation layer 52 (FIG. 3).

Furthermore, in the case of providing the insulation layer 52, the thickness is preferably equal to or less than 0.1 times the interelectrode distance (distance between the outer electrode 3a and the inner electrode 4a) so that a decrease in the electric field strength of the interelectrode distance does not become remarkable. More preferably, the interelectrode distance is equal to or less than 0.01 times.

On the other hand, the thickness of the insulation layer 51 is preferably equal to or greater than 5 times the thickness of the insulation layer 52, and more preferably 10 times or more. In other words, the thickness of the insulation layer 52 is preferably equal to or less than 0.2 times the thickness of the insulation layer 51, and is more preferably equal to or less than 0.1 times.

However, if the thickness of the insulation layer 51 is larger than the thickness of the insulation layer 52, it tends to have all of high damping characteristics, high performance stability, and high safety as compared with the case of uniformly forming the insulation layers 51 and 52, and therefore, the ratio is not particularly limited to the one described above. The thickness of the insulation layer 51 is set so as to reduce the electric field as much as possible in consideration of the material of the insulation layer, the applied voltage, the distance between the outer cylinder 3 and the base shell 2, the overall configuration of the cylinder device 1, and the like.

As for the roughness of the surfaces of the insulation layers 51 and 52, it is desirable that the unevenness pitch (average pitch between protrusions) of the surfaces be equal to or smaller than the average particle size of the particles constituting the dispersed phase contained in the electroviscous fluid 8. This is because there is a concern that particles are caught in the insulation layer and easily adhere to the insulation layer if this magnitude relationship is not satisfied. It is also desirable that the unevenness depth (average height of unevenness) of the surfaces of the insulation layers 51 and 52 be equal to or smaller than the average particle size of the particles constituting the dispersed phase.

Here, the average pitch between protrusions may be calculated in accordance with, for example, the average length of the contour curve element that is a parameter in the lateral direction of the Japanese Industrial Standard (JIS B0601: 2013), the number of peak counts based on the contour curve element, and the like. The average unevenness height may be calculated in accordance with, for example, the average height of the contour curve element of the Japanese Industrial Standard (JIS B0601: 2013).

As for the flow velocity of the electroviscous fluid 8 in contact with the surfaces of the insulation layers 51 and 52, the flow velocity on the insulation layer 52 side is generally higher by equal to or greater than 10 times than that on the insulation layer 51 side. Therefore, in the insulation layer 52, particles contained in the electroviscous fluid 8 are less likely to adhere than in the insulation layer 51. Therefore, also from this point of view, the thickness of the insulation layer 52 can be made thinner than that of the insulation layer 51.

Examples and comparative examples will be specifically described below, but the present invention is not limited to the following examples at all.

### Example 1

[Insulation layer]

The insulation layers 51 and 52 were provided at the positions illustrated in FIG. 2. Carbon steel was used as the material of the electrode, and polyamide was used as the material of the insulation layers 51 and 52. The thickness of the insulation layer 51 was about 100 times the thickness of the insulation layer 52.

[Electroviscous Fluid]

An electroviscous fluid in which polyurethane fine particles were dispersed in silicone oil was used. The average particle size of the polyurethane fine particles in accordance with the laser diffraction method is 4.2 μm, and the viscosity of the silicone oil is 5 cP.

### Comparative Example 1

Comparative Example 1 is different from Example 1 in that no insulation layer is provided in the electrode.

[Vibration Test]

The cylinder device was filled with an electroviscous fluid and a vibration test was conducted. The test conditions were a piston amplitude of 50 mm, a piston speed of 0.3 m/s, a temperature of 20° C., and an applied voltage of 5 kV.

For the result of the vibration test, the damping force of the cylinder device of Example 1 was set to 1 as a reference. The damping force of the cylinder device of Comparative Example 1 was as small as 0.9 times.

Measurement of the potential difference between the outer cylinder and the base shell during the vibration test indicates that in Example 1, the potential difference was dramatically reduced by providing the insulation layer, and there was almost no potential difference. In contrast, in the case of Comparative Example 1, a potential difference occurred.

Furthermore, after completion of the vibration test, the cylinder device was disassembled, and the amount of ions contained in the ERF was measured by an inductively coupled plasma mass spectrometer (ICP-MS). As a result, there was no significant change in Example 1. On the other hand, in the case of Comparative Example 1, there was a change in the amount of ions. This indicates that elution from the carbon steel constituting the electrode occurred due to the absence of the insulation layer.

The degree of adhesion of particles (particle adhesion degree) on the surface of the outer cylinder on the base shell side was visually confirmed. It is indicated that the smaller the particle adhesion degree is, the higher the function of preventing the deposition of particles is.

As a result, in the case of Example 1, the particle adhesion degree was moderate. In contrast, in the case of Comparative Example 1, the particle adhesion degree was large. When particles adhere to and accumulate on the surface of the outer cylinder, the damping characteristics deteriorate. By providing the insulation layer as in Example 1, it is possible to suppress deterioration of the damping characteristics.

As described above, it has been found that by providing insulation layers having different thicknesses on both sides of the outer cylinder, which is one of the electrodes, as in Example 1, it is possible to prevent deterioration of the electrodes of the cylinder device in which the electroviscous fluid is sealed, and it is possible to suppress an undesirable electric field from occurring between the outer cylinder and the base shell and suppress deterioration of damping characteristics.

Examples 2 to 5 and Comparative Example 2 will be described below. In the following examples and comparative example, vibration tests and the like were conducted in the same manner as in Example 1 and Comparative Example 1 described above.

### Example 2

The test was conducted in the same manner as in Example 1 except that a fluorine resin was used for the insulation layer material.

### Example 3

The test was conducted in the same manner as in Example 1 except that after a base of the insulation layer was formed with polyamide, its surface was coated with a fluorine surface treatment agent.

### Example 4

The test was conducted in the same manner as in Example 1 except that stainless steel was used for the material of the electrode and a fluorine resin was used for the material of the insulation layer.

### Example 5

The test was conducted in the same manner as in Example 1 except that stainless steel was used for the material of the electrode.

### Example 6

Stainless steel was used for the material of the electrode. After a base of the insulation layer was formed with polyamide, its surface was coated with a fluorine surface treatment agent. The test was conducted in the same manner as in Example 1 except for these.

### Example 7

Carbon was used for the material of the electrode. No insulation layer was provided on the inner surface of the outer cylinder 3. In other words, only the insulation layer 51 was provided as illustrated in FIG. 3. The test was conducted in the same manner as in Example 1 except for these.

### Example 8

As in Example 7, carbon was used for the material of the electrode.

A fluorine resin was used for the material of the insulation layer. The test was conducted in the same manner as in Example 7 except for this.

### Comparative Example 2

Carbon was used for the material of the electrode. The electrode was provided with no insulation layer. The test was conducted in the same manner as in Example 1 except for these.

Table 1 summarizes Example 1 to 8 and Comparative Example 1 and 2.

This table presents the material of the electrode, the material and formation location of the insulation layer, the damping force of the cylinder device, the presence or absence of eluted ions, the potential difference between the outer cylinder and the base shell, and the particle adhesion degree.

This table indicates that in Examples 2 to 4, 6, and 8, in which a fluorine resin was used for the insulation layer material, the cylinder device has a high damping force and a small particle adhesion degree.

TABLE 1

| | | | Insulation | | Eluted ions | Potential | |
|---|---|---|---|---|---|---|---|
| | | | layer | | to ERF after | difference between | Particle |
| | | Insulation layer | formation | Damping | vibration | outer electrode and | adhesion |
| | Electrode | material | location | force ratio | test | base shell | degree |
| Example 1 | Carbon | Polyamide | Both sides of | 1.0 | None | None | Moderate |
| | steel | | electrode | | | | |
| Comparative | | None | | 0.9 | Present | Present | Large |
| example 1 | | | | | | | |
| Example 2 | | Fluorine material | Both sides of | 1.2 | None | None | Small |
| Example 3 | | Polyamide/fluorine | electrode | 1.2 | | | |
| | | surface treatment | | | | | |
| Example 4 | Stainless | Fluorine material | Both sides of | 1.0 | | | |
| Example 5 | steel | Polyamide | electrode | 1.2 | | | Moderate |
| Example 6 | | Polyamide/fluorine | | 1.2 | | | Small |
| | | surface treatment | | | | | |
| Example 7 | Carbon | Polyamide | One side of | 1.0 | | | Moderate |
| Example 8 | electrode | Fluorine material | electrode | 1.2 | | | Small |

| | | | | |
|---|---|---|---|---|
| Comparative | None | 0.9 | Present | Large |
| example 2 | | | | |

Various embodiments have been described above, but the present invention is not limited thereto. The structure and components of the cylinder device are not limited to those described above.

### REFERENCE SIGNS LIST

1 cylinder device
2 base shell
2a upper end plate
3 outer cylinder
3a outer electrode
4 inner cylinder
4a inner electrode
5 lateral hole
6 rod
7 oil seal
8 electroviscous fluid
9 piston
9L piston lower chamber
9U piston upper chamber
9h,10h through hole
10 body
11 voltage application unit
13 inert gas
22,23,24 flow path
25 acceleration sensor
51,52 insulation layer

1. A cylinder device, comprising:
a piston rod having a piston;
a first electrode that constitutes an inner cylinder and into which the piston rod is inserted;
a second electrode that constitutes an outer cylinder and is provided so as to face an outer peripheral surface of the first electrode;
a base shell that houses the first electrode and the second electrode;
an electroviscous fluid sealed inside the base shell; and
a voltage application unit that applies a voltage between the first electrode and the second electrode,
wherein an outer surface insulation layer is provided on an outer peripheral surface of the second electrode.

2. The cylinder device according to claim 1, wherein an inner surface insulation layer is provided on an inner peripheral surface of the second electrode.

3. The cylinder device according to claim 2, wherein the inner surface insulation layer is thinner than the outer surface insulation layer.

4. The cylinder device according to claim 1, wherein an outermost surface layer of the outer surface insulation layer contains a fluorine material.

5. The cylinder device according to claim 2, wherein an outermost surface layer of the inner surface insulation layer contains a fluorine material.

6. The cylinder device according to claim 1,
wherein the electroviscous fluid contains particles having insulating properties, and
an average pitch between protrusions of unevenness on a surface of the outer surface insulation layer is equal to or smaller than an average particle size of the particles having insulating properties.

7. The cylinder device according to claim 6,
wherein an average unevenness height of the unevenness on a surface of the outer surface insulation layer is equal to or smaller than an average particle size of the particles having insulating properties.

8. The cylinder device according to claim 2, wherein a thickness of the inner surface insulation layer is equal to or less than 0.2 times a thickness of the outer surface insulation layer.

9. The cylinder device according to claim 2, wherein a thickness of the inner surface insulation layer is equal to or less than 0.1 times a distance between the first electrode and the second electrode.
